(19) United States
(12) Patent Application Publication
(10) Pub. No.: US 2016/0252832 A1
(43) Pub. Date: Sep. 1, 2016

(54) ELECTROPHOTOGRAPHIC PHOTOSENSITIVE MEMBER, PROCESS CARTRIDGE, AND ELECTROPHOTOGRAPHIC APPARATUS, AND MIXED CRYSTAL OF HYDROXYGALLIUM PHTHALOCYANINE AND CHLOROGALLIUM PHTHALOCYANINE AND METHOD OF PRODUCING THE CRYSTALLINE COMPLEX

(71) Applicant: CANON KABUSHIKI KAISHA, Tokyo (JP)

(72) Inventors: Masato Tanaka, Tagata-gun (JP); Tsutomu Nishida, Mishima-shi (JP); Hirofumi Kumoi, Suntou-gun (JP)

(21) Appl. No.: 15/054,006

(22) Filed: Feb. 25, 2016

(30) Foreign Application Priority Data
Feb. 27, 2015 (JP) 2015-039419

(51) Int. Cl. G03G 15/00

(52) U.S. Cl. CPC G03G 5/0696; G03G 5/047

(57) ABSTRACT

Provided is an electrophotographic photosensitive member including a support and a photosensitive layer. The photosensitive layer contains crystalline complexes of hydroxygallium phthalocyanine and chlorogallium phthalocyanine, the crystalline complexes containing an amide compound represented by Formula (1): R¹—NHCHO, where R¹ represents a methyl group, a propyl group, or a vinyl group.

### BACKGROUND OF THE INVENTION

1. Field of the Invention

The present invention relates an electrophotographic photosensitive member, a process cartridge including the electrophotographic photosensitive member, and an electrophotographic apparatus including the electrophotographic photosensitive member and relates to a crystalline complex comprising hydroxygallium phthalocyanine and chlorogallium phthalocyanine and a method of producing the crystalline complex.

2. Description of the Related Art

Semiconductor lasers, which are currently widely used as image exposure devices in the field of electrophotography, have a long oscillation wavelength of 650 to 820 nm, and electrophotographic photosensitive members having high sensitivity to such long wavelength light have been being developed.

Phthalocyanine pigment is effective as a charge generation material having a high sensitivity to light in a wavelength region including such a long wavelength. In particular, oxytitanium phthalocyanine and gallium phthalocyanine have excellent sensitivity characteristics, and a variety of their crystal forms have been reported.

Although an electrophotographic photosensitive member including phthalocyanine pigment has excellent sensitivity characteristics, the generated photocarrier is prone to remain in the photosensitive layer, leading to a problem of readily causing a potential change, such as a ghost phenomenon being a sort of memory.

Japanese Patent Laid-Open No. 2001-40237 describes that addition of a specific organic electron acceptor during an acid pasting process of phthalocyanine pigment provides an effect of enhancing the sensitivity. However, this production process has a problem that the additive (organic electron acceptor) has a risk of a chemical change and has a difficulty in conversion into a desired crystal form.

Japanese Patent Laid-Open No. 2006-72304 describes an improvement of electrophotographic characteristics by wet-pulverizing a pigment and a specific organic electron acceptor to simultaneously perform crystal transformation and incorporation of the organic electron acceptor into the surfaces of the crystals.

Japanese Patent Laid-Open No. 7-331107 discloses hydroxygallium phthalocyanine crystals containing a polar organic solvent. The use of a conversion solvent such as N,N-dimethylaminoformamide allows the polar organic solvent to be incorporated into the crystals to provide crystals having excellent sensitivity characteristics.

### SUMMARY OF THE INVENTION

The present invention provides an electrophotographic photosensitive member including a support and a photosensitive layer, wherein the photosensitive layer contains crystalline complexes comprising hydroxygallium phthalocyanine and chlorogallium phthalocyanine; and the crystalline complexes contain an amide compound represented by Formula (1):

R¹—NHCHO (1)

where R¹ represents a methyl group, a propyl group, or a vinyl group.

The present invention also provides a process cartridge integrally supporting the electrophotographic photosensitive member and at least one device selected from the group consisting of a charging device, a developing device, and a cleaning device and being detachably attachable to an electrophotographic apparatus main body.

The present invention also provides an electrophotographic apparatus comprising the electrophotographic photosensitive member and a charging device, an exposure device, a developing device, and a transferring device.

The present invention also provides crystalline complexes comprising hydroxygallium phthalocyanine and chlorogallium phthalocyanine containing an amide compound represented by Formula (1).

The present invention also provides a method of producing the crystalline complexes comprising hydroxygallium phthalocyanine and chlorogallium phthalocyanine, comprising milling treatment of hydroxygallium phthalocyanine prepared by acid pasting, chlorogallium phthalocyanine, and an amide compound represented by Formula (1).

Further features of the present invention will become apparent from the following description of exemplary embodiments with reference to the attached drawings.

### BRIEF DESCRIPTION OF THE DRAWINGS

FIG. 1 is a diagram schematically illustrating an example of the structure of an electrophotographic apparatus provided with a process cartridge including an electrophotographic photosensitive member.

FIG. 2 is a powder X-ray diffraction pattern of the gallium phthalocyanine crystalline complexes prepared in Example 1-1.

FIG. 3 is a powder X-ray diffraction pattern of the gallium phthalocyanine crystalline complexes prepared in Example 1-2.

FIG. 4 is a powder X-ray diffraction pattern of the gallium phthalocyanine crystalline complexes prepared in Example 1-3.

FIG. 5 is a powder X-ray diffraction pattern of the gallium phthalocyanine crystalline complexes prepared in Example 1-4.

FIG. 6 is a powder X-ray diffraction pattern of the gallium phthalocyanine crystalline complexes prepared in Example 1-7.

FIG. 7 is a powder X-ray diffraction pattern of the hydroxygallium phthalocyanine crystals prepared in Comparative Example 1-1.

FIG. 8 is a powder X-ray diffraction pattern of the hydroxygallium phthalocyanine crystals prepared in Comparative Example 1-3.

FIGS. 9A and 9B are diagrams illustrating examples of the layer configuration of an electrophotographic photosensitive member.

FIG. 10 is an NMR spectrum of the gallium phthalocyanine crystalline complexes prepared in Example 1-1.

FIG. 11 is an NMR spectrum of the hydroxygallium phthalocyanine crystals prepared in Comparative Example 1-1.

### DESCRIPTION OF THE EMBODIMENTS

A further increase in image quality in recent years demands a decrease in the deterioration caused by a ghost phenomenon in image quality under various environments. In particular, the ghost phenomenon is prone to occur under a low temperature and low humidity environment, and a further improvement is required.

It was however revealed that the technologies described in Japanese Patent Laid-Open Nos. 2006-72304 and 7-331107 cannot sufficiently decrease the deterioration caused by a ghost phenomenon in image quality in some cases. The phthalocyanine crystals described in Japanese Patent Laid-Open No. 2006-72304 do not contain an organic electron acceptor inside the crystals, and the organic electron acceptor is merely mixed with the crystals or merely adhering to the surfaces of the crystals. Consequently, the effect of the organic electron acceptor in reducing the remaining photocarrier is insufficient, leading to a risk of causing a ghost phenomenon. It was also revealed that in the hydroxygallium phthalocyanine crystals described in Japanese Patent Laid-Open No. 7-331107, the remaining photocarrier increases to readily cause a ghost phenomenon.

The purpose of the present invention is to provide an electrophotographic photosensitive member giving images having reduced defects caused by a ghost phenomenon under a normal temperature and normal humidity environment and also under strict conditions of a low temperature and low humidity environment and to provide a process cartridge including the electrophotographic photosensitive member and an electrophotographic apparatus including the electrophotographic photosensitive member.

Another purpose of the present invention is to provide crystalline complexes comprising hydroxygallium phthalocyanine and chlorogallium phthalocyanine having excellent characteristics as a charge generation material and a method of producing the crystalline complexes.

### <Electrophotographic Photosensitive Member>

The electrophotographic photosensitive member of the present invention includes a support and a photosensitive layer.

The photosensitive layer contains crystalline complexes of hydroxygallium phthalocyanine and chlorogallium phthalocyanine, and the crystalline complexes contains an amide compound represented by Formula (1):

R¹—NHCHO (1)

where R¹ represents a methyl group, a propyl group, or a vinyl group.

In the present invention, the term “the crystalline complex comprising hydroxygallium phthalocyanine and chlorogallium phthalocyanine” is multi-component crystal or crystalline material comprising hydroxygallium phthalocyanine and chlorogallium phthalocyanine. The crystalline complex is also termed as co-crystal. The term “crystalline complex comprising hydroxygallium phthalocyanine and chlorogallium phthalocyanine” is also referred to as “gallium phthalocyanine crystalline complex”.

### [Crystalline Complex Comprising Hydroxygallium Phthalocyanine and Chlorogallium Phthalocyanine]

The hydroxygallium phthalocyanine constituting the gallium phthalocyanine crystalline complex includes a gallium atom as the central metal of the phthalocyanine ring and includes a hydroxy group as an axial ligand to the gallium atom. The chlorogallium phthalocyanine constituting the gallium phthalocyanine crystalline complex includes a gallium atom as the central metal of the phthalocyanine ring and includes a chlorine atom as an axial ligand to the gallium atom. Each phthalocyanine ring may include a substituent, such as a halogen atom.

The gallium phthalocyanine crystalline complex that has peaks at Bragg angles 2θ of 7.40±0.30 and 28.30±0.30 in an X-ray diffraction spectrum with CU—Kα ray has high sensitive electrophotographic characteristics.

The gallium phthalocyanine crystalline complex can further contain a compound represented by Formula (2):

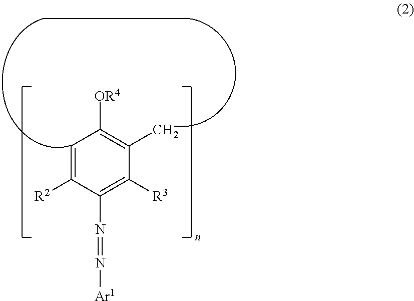

where n represents an integer of 4 to 8; R²'s each independently represent a hydrogen atom or an alkyl group; R³'s each independently represent a hydrogen atom or an alkyl group; R⁴'s each independently represent a hydrogen atom or a substituted or unsubstituted alkyl group; and Ar¹'s each independently represent a substituted or unsubstituted aromatic hydrocarbon ring, a substituted or unsubstituted heterocycle, or a monovalent group formed by bonding of two or more groups selected from the group consisting of substituted aromatic hydrocarbon rings, unsubstituted aromatic hydrocarbon rings, substituted heterocycles, and unsubstituted heterocycles.

The gallium phthalocyanine crystalline complex containing a compound represented by Formula (2) can further prevent the occurrence of image defects caused by a ghost phenomenon.

The gallium phthalocyanine crystalline complex can further contain a compound represented by Formula (3) or (4):

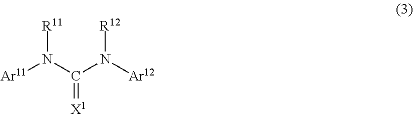

where R¹¹ and R¹² each independently represent a hydrogen atom or an alkyl group; X¹ represents an oxygen atom or a sulfur atom; and Ar¹¹ and Ar¹² each independently represent a hydrogen atom or a substituted or unsubstituted aryl group, provided that at least one of Ar¹¹ and Ar¹² represents a substituted or unsubstituted aryl group, wherein

the substituent of the substituted aryl group is a cyano group, a dialkylamino group, a hydroxy group, an alkyl group, an alkoxy-substituted alkyl group, a halogen-substituted alkyl group, an alkoxy group, an alkoxy-substituted alkoxy group, a halogen-substituted alkoxy group, a nitro group, or a halogen atom,

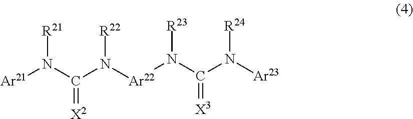

where R²¹ to R²⁴ each independently represent a hydrogen atom or an alkyl group; X² and X³ each independently represent an oxygen atom or a sulfur atom; Ar²² represents a substituted or unsubstituted arylene group; and Ar²¹ and Ar²³ each independently represent a hydrogen atom or a substituted or unsubstituted aryl group, provided that at least one of Ar²¹ and Ar²³ represents a substituted or unsubstituted aryl group, wherein

the substituent of the substituted arylene group is an alkyl group, an alkoxy-substituted alkyl group, a halogen-substituted alkyl group, an alkoxy group, an alkoxy-substituted alkoxy group, a halogen-substituted alkoxy group, or a halogen atom; and

the substituent of the substituted aryl group is a cyano group, a dialkylamino group, a hydroxy group, an alkyl group, an alkoxy-substituted alkyl group, a halogen-substituted alkyl group, an alkoxy group, an alkoxy-substituted alkoxy group, a halogen-substituted alkoxy group, a nitro group, or a halogen atom.

The gallium phthalocyanine crystalline complexes containing a compound represented by Formula (3) or (4) can further prevent the occurrence of image defects caused by a ghost phenomenon.

A method of producing gallium phthalocyanine crystalline complexes containing an amide compound represented by Formula (1) will be described.

The gallium phthalocyanine crystalline complexes containing an amide compound represented by Formula (1) can be prepared by preparing hydroxygallium phthalocyanine by acid pasting or dry milling and subjecting the hydroxygallium phthalocyanine to wet milling together with chlorogallium phthalocyanine and an amide compound represented by Formula (1). In order to prepare gallium phthalocyanine crystalline complexes having a higher sensitivity, the hydroxygallium phthalocyanine is prepared by acid pasting.

In the production of gallium phthalocyanine crystalline complexes further containing a compound represented by any of Formulae (2) to (4), the compound may be added during the wet milling.

The wet milling herein is a treatment performed with a milling apparatus, such as a sand mill, a ball mill, or a stirring apparatus, and may use a dispersant, such as glass beads, steel beads, or alumina beads, as necessary. The milling time can be about 20 to 1000 hr. In particular, samples may be taken out from the mill every 10 to 50 hr to determine the content of the amide compound represented Formula (1) by measuring the Bragg angle and NMR of the crystals.

The amount of the dispersant that is optionally used in the milling treatment can be 10- to 50-fold the sum total based on mass of hydroxygallium phthalocyanine and chlorogallium phthalocyanine.

The content of the amide compound represented by Formula (1) can be 5- to 30-fold the sum total based on mass of hydroxygallium phthalocyanine and chlorogallium phthalocyanine.

In order to achieve both of the excellent sensitivity characteristics against long-wavelength light and the prevention of image defects caused by a ghost phenomenon at higher degrees, the content of hydroxygallium phthalocyanine in the crystalline complex can be higher than that of chlorogallium phthalocyanine. That is, the ratio of the content of hydroxygallium phthalocyanine to the content of chlorogallium phthalocyanine in the crystalline complex can be 5/5 or more. Furthermore, the ratio of the content of hydroxygallium phthalocyanine to the content of chlorogallium phthalocyanine in the crystalline complex can be 70/30 or more and 95/5 or less.

From the viewpoint of preventing image defects caused by a ghost phenomenon, the amide compound represented by Formula (1) can be N-methylformamide, which has high compatibility with gallium phthalocyanine and, in particular, has a property to be readily polarized. That is, this property probably allows the amide compound to be readily incorporated into the crystalline complex and further prevents a charge from being in the staying state, which causes a ghost phenomenon, in the crystalline complex.

The content of the amide compound represented by Formula (1) contained in the crystalline complex can be 0.1% by mass or more and 3.0% by mass or less, more preferably 0.4% by mass or more and 2.0% by mass or less, based on the amount of the gallium phthalocyanine compound. A content of the amide compound represented by Formula (1) within the above-mentioned range can further prevent image defects caused by a ghost phenomenon.

In the present invention, whether the gallium phthalocyanine crystalline complexes contain the amide compound represented by Formula (1) or not is determined by analyzing the NMR data of the resulting gallium phthalocyanine crystalline complexes.

In the present invention, X-ray diffraction and NMR of the gallium phthalocyanine crystalline complexes were measured under the following conditions.

### [Measurement of Powder X-Ray Diffraction]

Measurement apparatus used: X-ray diffractometer, RINT-TTRII, manufactured by Rigaku Corporation

X-ray tube: Cu

Tube voltage: 50 KV

Tube current: 300 mA

Scanning method: 2θ/θ scan

Scanning rate: 4.0°/min

Sampling interval: 0.02°

Starting angle (2θ): 5.0°

Stopping angle (2θ): 40.0°

Attachment: standard sample holder

Filter: non-use

Incident monochrome: use

Counter monochrometer: non-use

Divergence slit: open

Divergence vertical limitation slit: 10.00 mm

Scattering slit: open

Light-receiving slit: open

Plate monochrometer: use

Counter: scintillation counter

### [Measurement of NMR (¹H-NMR Measurement)]

Measurement apparatus used: AVANCEIII 500 manufactured by Bruker Corporation

Measurement nuclide: ¹H

Solvent: deuterium sulfate (D₂SO₄)

Cumulative number: 2000

The gallium phthalocyanine crystalline complexes containing an amide compound represented by Formula (1) have an excellent photoconductor function and can also be applied to, for example, a solar cell, a sensor, or a switching element, in addition to the electrophotographic photosensitive member.

Use of the gallium phthalocyanine crystalline complexes containing an amide compound represented by Formula (1) as a charge generation material of an electrophotographic photosensitive member will now be described.

The electrophotographic photosensitive member of the present invention includes a support and a photosensitive layer formed on the support. The photosensitive layer is a monolayer type photosensitive layer containing both a charge generation material and a charge transport material or a multi-layer type photosensitive layer composed of a charge generation sub-layer containing a charge generation material and a charge transport sub-layer containing a charge transport material. In particular, the photosensitive layer can be a multi-layer type photosensitive layer including a charge generation sub-layer and a charge transport sub-layer formed on the charge generation sub-layer.

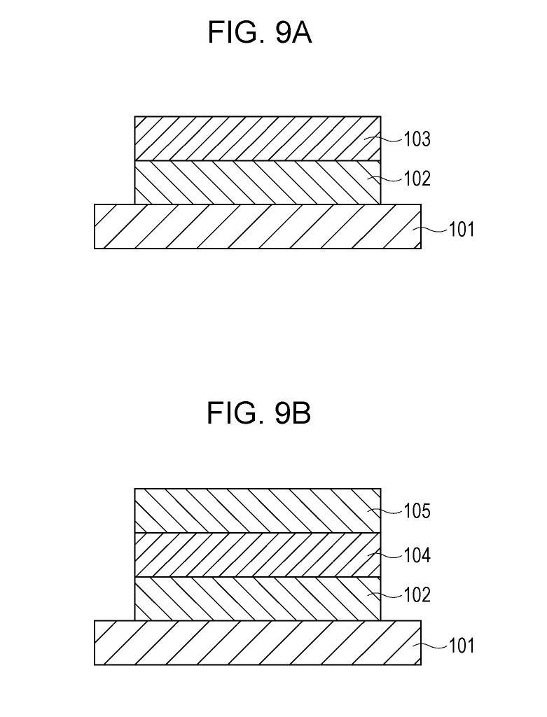

FIGS. 9A and 9B are diagrams illustrating examples of the layer configuration of the electrophotographic photosensitive member of the present invention. In FIGS. 9A and 9B, reference number 101 indicates a support, reference number 102 indicates an undercoat layer, reference number 103 indicates a photosensitive layer, reference number 104 indicates a charge generation sub-layer, and reference number 105 indicates a charge transport sub-layer.

### [Support]

The support can be electrically conductive (conductive support). For example, the support is made of a metal or alloy, such as aluminum, an aluminum alloy, copper, zinc, stainless steel, vanadium, molybdenum, chromium, titanium, nickel, indium, gold, or platinum. A support made of a resin having a cover layer formed by vacuum deposition of aluminum, an aluminum alloy, indium oxide, tin oxide, or an indium oxide-tin oxide alloy can also be used. In addition, for example, plastic or paper impregnated with conductive particles or plastic including a conductive polymer also can be used as the support. In order to prevent interference fringes from being caused by scattering of laser beams, the surface of the support may be subjected to cutting, roughing, alumite treatment, combined electropolishing, wet honing, or dry honing.

### [Conductive Layer]

Furthermore, in order to prevent interference fringes from being caused by scattering of laser beams or to mask (cover) scratches of the support, a conductive layer may be disposed between the support and the undercoat layer described below. The conductive layer can be formed by forming a coating film of a conductive layer coating solution by application and drying the resulting coating film. The conductive layer coating solution can be prepared by dispersion treatment of conductive particles, such as carbon black, metal particles, or metal oxide particles, and a binder resin in a solvent.

Examples of the conductive particles include aluminum particles, titanium oxide particles, tin oxide particles, zinc oxide particles, carbon black, and silver particles. Examples of the binder resin include polyesters, polycarbonates, polyvinyl butyrals, acrylic resins, silicone resins, epoxy resins, melamine resins, urethane resins, phenol resins, and alkyd resins. Examples of the solvent of the conductive layer coating solution include ether solvents, alcohol solvents, ketone solvents, and aromatic hydrocarbon solvents.

### [Undercoat Layer]

An undercoat layer (also called barrier layer or intermediate layer) having a barrier function and an adhesive function may be disposed between the support and the photosensitive layer. The undercoat layer can be formed by forming a coating film of an undercoat layer coating solution prepared by mixing a binder resin with a solvent and drying the resulting coating film. Furthermore, in order to reduce the potential change of the electrophotographic photosensitive member, the undercoat layer may contain a resistance control agent, an electron transporting compound, or an acceptor compound.

Examples of the binder resin include polyvinyl alcohol, polyethylene oxide, ethyl cellulose, methyl cellulose, casein, polyamides (e.g., Nylon 6, Nylon 66, Nylon 610, copolymer nylon, and N-alkoxy methylated nylon), polyurethane, acrylic resins, allyl resins, alkyd resins, and epoxy resins. The undercoat layer can have a thickness of 0.1 to 10 μm, more preferably 0.5 to 5 μm. Examples of the solvent of the undercoat layer coating solution include ether solvents, alcohol solvents, ketone solvents, and aromatic hydrocarbon solvents. Examples of the resistance control agent include titanium oxide particles, tin oxide particles, and zinc oxide particles. Examples of the electron transporting compound and the acceptor compound include N type pigments, such as azo pigments and perylene pigments, and aromatic ketone compounds, such as benzoquinone, anthraquinone, alizarin, and benzanthrone.

### [Photosensitive Layer]

In the present invention, the photosensitive layer may be of a monolayer type or a multi-layer type (including a charge generation sub-layer and a charge transport sub-layer in this order from the support side). In the multi-layer type photosensitive layer, the electrophotographic photosensitive member of the present invention includes a support, a charge generation sub-layer, and a charge transport sub-layer in this order. The function of the charge generation material can be efficiently achieved in the multi-layer type compared with that in the monolayer type.

The photosensitive layer can be formed by application, such as dipping, spray coating, spinner coating, bead coating, blade coating, or beam coating.

### (Case of Monolayer Type Photosensitive Layer)

In the monolayer type photosensitive layer, gallium phthalocyanine crystalline complexes containing an amide compound represented by Formula (1) as a charge generation material, a charge transport material, and a binder resin are mixed with a solvent to prepare a coating solution. This coating solution is formed into a coating film, and the resulting coating film is dried into a monolayer type photosensitive layer.

Examples of the binder resin include polycarbonates, polyesters, butyral resins, polyvinyl acetals, acrylic resins, vinyl acetate resins, and urea resins. Among these binder resins, butyral resins can be particularly used. These binder resins may be used alone or as a mixture or a copolymer of two or more thereof.

Examples of the solvent that is used in the coating solution for the monolayer type photosensitive layer include alcohol solvents, sulfoxide solvents, ketone solvents, ether solvents, ester solvents, and aromatic hydrocarbon solvents. These solvents may be used alone or in a combination of two or more thereof.

The content of the charge generation material can be 3% to 30% by mass based on the total mass of the photosensitive layer. The content of the charge transport material can be 30% to 70% by mass based on the total mass of the photosensitive layer. The monolayer type photosensitive layer can have a thickness of 5 to 40 μm, more preferably 10 to 30 μm.

In the present invention, although the gallium phthalocyanine crystalline complexes containing an amide compound represented by Formula (1) in the crystals are used as a charge generation material, the gallium phthalocyanine crystalline complexes may be used as a mixture with another charge generation material. In such a case, the content of the gallium phthalocyanine crystalline complexes containing an amide compound represented by Formula (1) can be 50% by mass or more based on the total amount of the charge generation material.

### (Case of Multi-Layer Type Photosensitive Layer)

### (i) Charge Generation Sub-Layer

The charge generation sub-layer may be formed as follows: The gallium phthalocyanine crystalline complexes, as a charge generation material, containing an amide compound represented by Formula (1) and a binder resin are mixed with a solvent to prepare a charge generation sub-layer coating solution. This charge generation sub-layer coating solution is formed into a coating film, and the resulting coating film is dried into a charge generation sub-layer. The charge generation sub-layer can also be formed by deposition.

Examples of the binder resin include polycarbonates, polyesters, butyral resins, polyvinyl acetals, acrylic resins, vinyl acetate resins, and urea resins. Among these binder resins, butyral resins can be particularly used. These binder resins may be used alone or as a mixture or a copolymer of two or more thereof.

Examples of the solvent used in the charge generation sub-layer coating solution include alcohol solvents, sulfoxide solvents, ketone solvents, ether solvents, ester solvents, and aromatic hydrocarbon solvents. These solvents may be used alone or in a combination of two or more thereof.

The content of the charge generation material can be 20% to 90% by mass, more preferably 50% to 80% by mass, based on the total mass of the charge generation sub-layer. The charge generation sub-layer can have a thickness of 0.01 to 10 μm, more preferably 0.1 to 3 μm.

In the present invention, although the gallium phthalocyanine crystalline complexes containing an amide compound represented by Formula (1) are used as a charge generation material, the gallium phthalocyanine crystalline complexes may be used as a mixture with another charge generation material. In such a case, the content of the gallium phthalocyanine crystalline complexes containing an amide compound represented by Formula (1) can be 50% by mass or more based on the total mass of the charge generation material.

### (ii) Charge Transport Sub-Layer

The charge transport sub-layer can be formed by applying a charge transport sub-layer coating solution to form a coating film and drying the resulting coating film. The charge transport sub-layer coating solution can be prepared by dissolving a charge transport material and a binder resin in a solvent.

Examples of the charge transport material include triarylamine compounds, hydrazone compounds, stilbene compounds, pyrazoline compounds, oxazole compounds, thiazole compounds, and triallylmethane compounds.

Examples of the binder resin used in the charge transport sub-layer include polyesters, acrylic resins, polyvinylcarbazoles, phenoxy resins, polycarbonates, polyvinyl butyral, polystyrene, polyvinyl acetate, polysulfone, polyarylate, polyvinylidene chloride, acrylonitrile copolymers, and polyvinyl benzal.

The content of the charge transport material can be 20% to 80% by mass, more preferably 30% to 70% by mass, based on the total mass of the charge transport sub-layer. The charge transport sub-layer can have a thickness of 5 to 40 μm, more preferably 10 to 30 μm.

### [Protective Layer]

A protective layer may be disposed on the photosensitive layer as necessary. The protective layer can be formed by forming a coating film of a protective layer coating solution prepared by dissolving a binder resin in a solvent and drying the coating film. Examples of the binder resin include polyvinyl butyrals, polyesters, polycarbonates (such as polycarbonate Z and modified polycarbonate), nylon, polyimides, polyacrylates, polyurethanes, styrene-butadiene copolymers, styrene-acrylic copolymers, and styrene-acrylonitrile copolymers.

Alternatively, the protective layer may be formed by hardening a monomer having charge transportability (hole transportability) by various polymerization or cross-linking reactions for imparting charge transportability to the protective layer. Specifically, the protective layer can be formed by polymerizing or cross-linking and hardening a charge transporting compound (hole transporting compound) having a chain polymerizable functional group.

The protective layer can have a thickness of 0.05 to 20 μm. The protective layer may contain conductive particles or a UV absorber. Examples of the conductive particles include metal oxide particles, such as tin oxide particles.

### <Process Cartridge and Electrophotographic Apparatus>

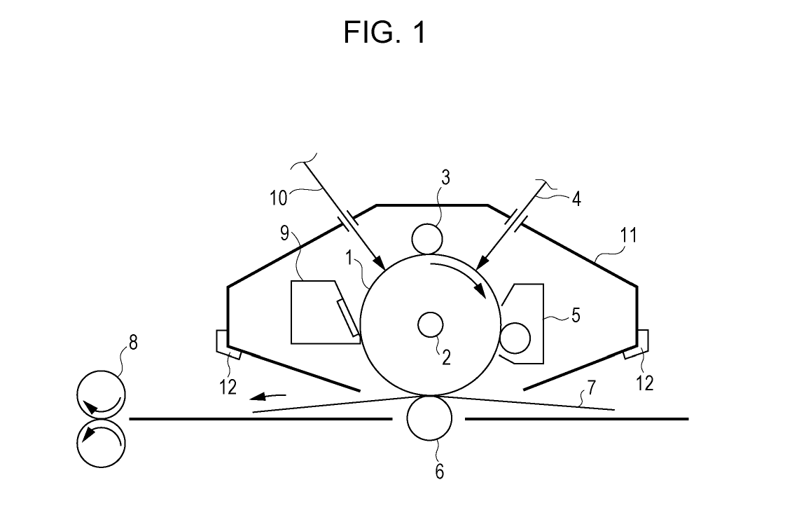

FIG. 1 is a diagram schematically illustrating an example of the structure of an electrophotographic apparatus provided with a process cartridge including an electrophotographic photosensitive member.

In FIG. 1, a cylindrical (drum-shaped) electrophotographic photosensitive member 1 is rotationally driven on the central in the direction of the arrow at a prescribed circumferential velocity (process speed).

In the rotation process, the surface of the electrophotographic photosensitive member 1 is charged to a prescribed positive or negative potential with a charging device 3. Subsequently, the surface of the charged electrophotographic photosensitive member 1 is irradiated with image exposure light 4 from an image exposure device (not shown), leading to formation of an electrostatic latent image corresponding to objective image information. The image exposure light 4 is, for example, light having a modulated intensity corresponding to a time-series electric digital image signal of objective image information, output from an image exposure device, such as slit exposure or laser beam scanning exposure.

The electrostatic latent image formed on the surface of the electrophotographic photosensitive member 1 is developed (normal development or reversal development) with a developing agent (toner) accommodated in a developing device 5 to form a toner image on the surface of the electrophotographic photosensitive member 1. The toner image formed on the surface of the electrophotographic photosensitive member 1 is transferred to a transferring material 7 with a transferring device 6. On this occasion, a voltage (transfer bias) having a polarity opposite to the charge possessed by the toner is applied to the transferring device 6 from a bias power source (not shown). The transferring material 7 is taken out from a transfer material-supplying device (not shown) synchronizing with the rotation of the electrophotographic photosensitive member 1 and is supplied to between the electrophotographic photosensitive member 1 and the transferring device 6 (contact portion).

The toner image-transferred transferring material 7 is separated from the surface of the electrophotographic photosensitive member 1, is transported to an image fixing device 8 to receive toner image-fixing treatment, and is printed out to the outside of the electrophotographic apparatus as an image-formed product (print or copy).

The surface of the electrophotographic photosensitive member 1 after the transfer of the toner image to the transferring material 7 is cleaned by removing the attached matter, such as the untransferred developing agent (untransferred toner), with a cleaning device 9. Alternatively, the untransferred toner can be collected with, for example, a developing device (cleanerless system).

The surface of the electrophotographic photosensitive member 1 is further irradiated with pre-exposure light 10 from a pre-exposure device (not shown) and is subjected to discharging treatment and is then repeatedly used in image formation. As shown in FIG. 1, when the charging device 3 is a contact charging device using, for example, charging rollers, the pre-exposure device is not necessarily needed.

In the present invention, among the components such as the above-mentioned electrophotographic photosensitive member 1, charging device 3, developing device 5, and cleaning device 9, two or more components may be accommodated in a container to be integrally supported to form a process cartridge. This process cartridge can be constituted to be detachably attached to an electrophotographic apparatus main body. For example, the electrophotographic photosensitive member 1 and at least one selected from the charging device 3, developing device 5, and cleaning device 9 are integrally supported to form a cartridge. This cartridge can be formed into a process cartridge 11 detachably attachable to an electrophotographic apparatus main body with a guiding device 12, such as a rail, of the electrophotographic apparatus main body.

The image exposure light 4 when the electrophotographic apparatus is a copier or a printer may be reflected light or transmitted from the original. Alternatively, the image exposure light 4 may be light that is emitted when a sensor reads the original and converts it to signals and scanning of laser beams, driving of an LED array, or driving a liquid crystal shutter array is performed according to the signals.

### EXAMPLES

The present invention will now be described in more detail by the way of examples, but is not limited thereto. In the following description, the term “part(s)” means “part(s) by mass”, and the term “%” means “% by mass”. The thickness of each layer of the electrophotographic photosensitive members of Examples and Comparative Examples was measured with an eddy-current thickness meter (Fischerscope, manufactured by Helmut Fischer GmbH) or was determined from the mass per unit area in terms of specific gravity.

### Synthesis of Gallium Phthalocyanine Pigment

### Synthesis Example 1

Under a nitrogen flow, phthalonitrile (5.46 parts) and α-chloronaphthalene (45 parts) were fed to a reaction tank and were heated to a temperature of 30° C., and this temperature was maintained. Subsequently, gallium trichloride (3.75 parts) was fed thereto at this temperature (30° C.). The moisture value of the mixture solution at the time of the feeding was 150 ppm. The temperature was then raised to 200° C., followed by a reaction at 200° C. for 4.5 hr under a nitrogen flow. The reaction mixture was then cooled and was filtered when the temperature reached 150° C. to collect the product. The resulting filtrate was washed by dispersion in N,N-dimethylformamide at 140° C. for 2 hr and was then filtered. The resulting filtrate was washed with methanol and was then dried to give 4.65 parts (yield: 71%) of a chlorogallium phthalocyanine pigment.

### Synthesis Example 2

The chlorogallium phthalocyanine pigment (4.65 parts) prepared in Synthesis Example 1 was dissolved in concentrated sulfuric acid (139.5 parts) at 10° C. and was reprecipitated by dropping into iced water (620 parts) with stirring, followed by filtration by filter press. The resulting wet cake (filtrate) was washed by dispersion in 2% ammonia water and was then filtered by filter press. Subsequently, the resulting wet cake (filtrate) was washed by dispersion in deionized water and was then filtered by filter press three times to give 18.6 parts of a hydrous hydroxygallium phthalocyanine pigment having a solid content of 23%.

Subsequently, the resulting hydrous hydroxygallium phthalocyanine pigment (6.6 parts) was dried with a dryer (trade name: Hyper-Dry HD-06R, frequency (oscillation frequency): 2455±15 MHz, manufactured by Biocon Japan Ltd.) as follows.

The hydrous hydroxygallium phthalocyanine pigment in a lump state (hydrous cake thickness: 4 cm or less), as taken out from the filter press, was put on an exclusive circular plastic tray of the dryer set such that the far infrared was off and the temperature of the inner wall was 50° C. A vacuum pump and a leak valve were adjusted to give a degree of vacuum of 4.0 to 10.0 kPa during microwave irradiation.

As a first step, the hydroxygallium phthalocyanine pigment was irradiated with a microwave of 4.8 kW for 50 min. The irradiation with microwave was then stopped and the leak valve was closed for a moment so as to give a high degree of vacuum of 2 kPa or less. At this point, the hydroxygallium phthalocyanine pigment had a solid content of 88%.

As a second step, the leak valve was adjusted so as to give a degree of vacuum (pressure inside the dryer) within the above-mentioned setting value (4.0 to 10.0 kPa), and the hydroxygallium phthalocyanine pigment was then irradiated with a microwave of 1.2 kW for 5 min. The irradiation with microwave was then stopped and the leak valve was closed for a moment so as to give a high degree of vacuum of 2 kPa or less. The second step was further performed once (twice in total). At this point, the hydroxygallium phthalocyanine pigment had a solid content of 98%.

As a third step, irradiation with microwave was performed as in the second step except that a microwave of 0.8 kW was used instead of the microwave of 1.2 kW in the second step. The third step was further performed once (twice in total).

As a fourth step, the leak valve was adjusted so as to give a degree of vacuum (pressure inside the dryer) within the above-mentioned setting value (4.0 to 10.0 kPa) again, and the hydroxygallium phthalocyanine pigment was then irradiated with a microwave of 0.4 kW for 3 min. The irradiation with microwave was then stopped and the leak valve was closed for a moment so as to give a high degree of vacuum of 2 kPa or less. The fourth step was further repeated seven times (eight times in total).

As a result, 1.52 parts of a hydroxygallium phthalocyanine pigment having a water content of 1% or less was prepared for 3 hr in total.

### Synthesis Example 3

The hydroxygallium phthalocyanine pigment (1 part) prepared in Synthesis Example 2 was mixed with an aqueous hydrochloric acid solution (20 parts) having a concentration of 35% by mass, followed by stirred at room temperature for 90 min. After the stirring, the dispersion solution was dropped into iced water (100 parts), followed by stirring for 30 min. The resulting dispersion was filtered under reduced pressure through a filter paper No. 5C (manufactured by Advantech Co., Ltd.). Dispersion-washing and filtration of the resulting wet cake (filtrate) were repeated four times. The resulting hydrous wet cake (filtrate) was freeze-dried to give 0.9 parts of a chlorogallium phthalocyanine pigment.

### Examples 1-1 to 1-11 and Comparative Examples 1-1 to 1-3

### Example 1-1

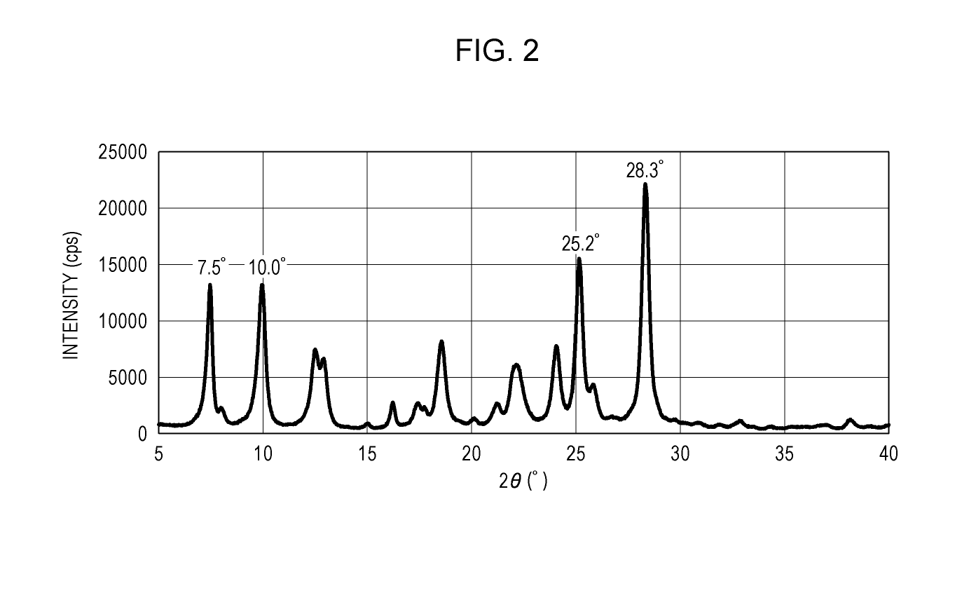

The hydroxygallium phthalocyanine pigment (0.45 parts) prepared in Synthesis Example 2, the chlorogallium phthalocyanine pigment (0.05 parts) prepared in Synthesis Example 3, and N-methylformamide (10 parts) were milled with a ball mill using glass beads (20 parts) having a diameter of 0.8 mm at room temperature (23° C.) for 800 hr. The milling was performed using a standardized bottle (product code: PS-6, manufactured by Hakuyo Glass Co., Ltd.) as the container under conditions such that the container rotates 120 times per minute. Tetrahydrofuran (30 parts) was added to the thus-prepared dispersion. The mixture was then filtered with a filter, and the filtrate remained in the filter was further sufficiently washed with tetrahydrofuran. The washed filtrate was vacuum-dried to give 0.47 parts of gallium phthalocyanine crystalline complexes. FIG. 2 shows the powder X-ray diffraction pattern of the resulting crystalline complexes.

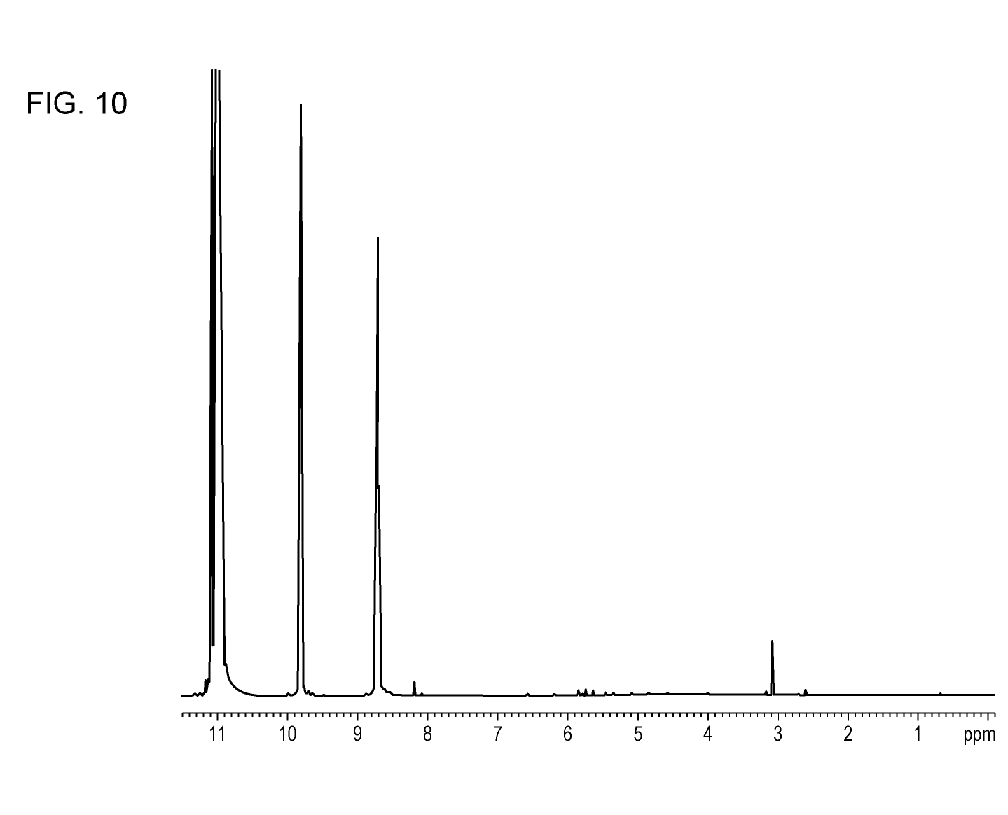

In addition, NMR measurement showed that the amount of N-methylformamide contained in the gallium phthalocyanine crystalline complexes prepared in Example 1-1 was 0.8% by mass relative to the amount of gallium phthalocyanine when calculated from the proton ratio. Since N-methylformamide has compatibility to tetrahydrofuran, N-methylformamide can be judged to be contained in the crystalline complexes. FIG. 10 shows the NMR spectrum of the resulting gallium phthalocyanine crystalline complexes.

### Example 1-2

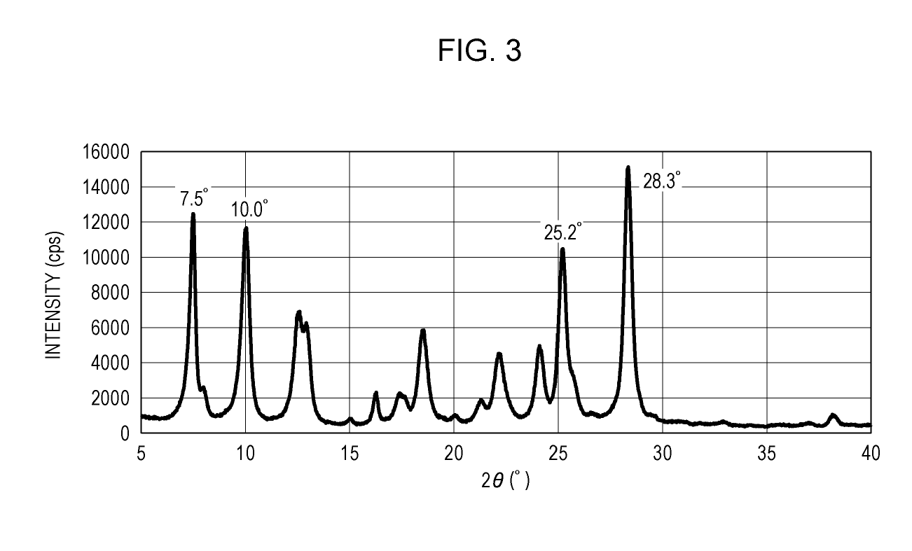

Gallium phthalocyanine crystalline complexes (0.48 parts) was prepared as in Example 1-1 except that the amount of the hydroxygallium phthalocyanine pigment prepared in Synthesis Example 2 was 0.40 parts instead of 0.45 parts in Example 1-1 and that the amount of the chlorogallium phthalocyanine pigment prepared in Synthesis Example 3 was 0.10 parts instead of 0.05 parts in Example 1-1. FIG. 3 shows the powder X-ray diffraction pattern of the resulting crystalline complexes.

NMR measurement showed that the amount of N-methylformamide contained in the gallium phthalocyanine crystalline complexes prepared in Example 1-2 was 0.6% by mass relative to the amount of gallium phthalocyanine when calculated from the proton ratio.

### Example 1-3

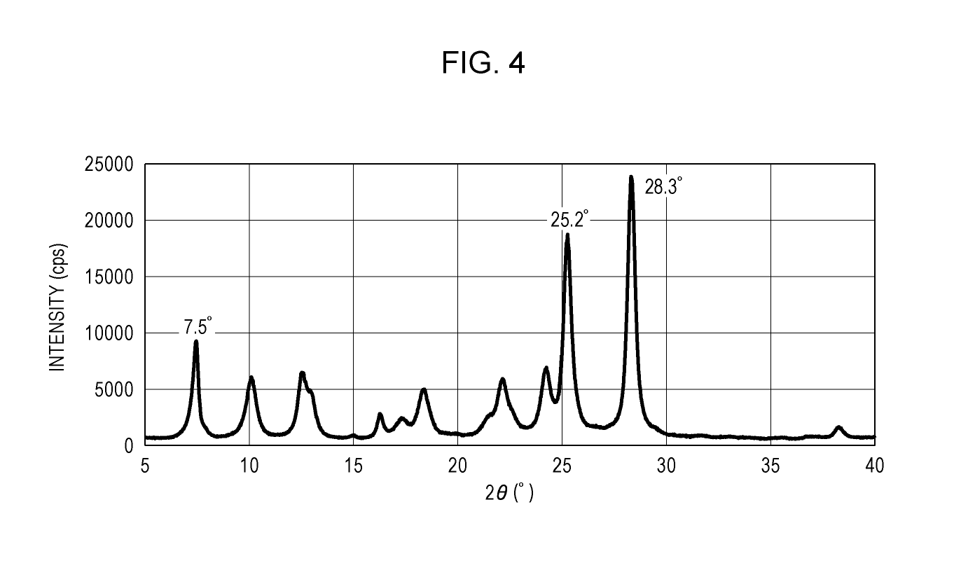

Gallium phthalocyanine crystalline complexes (0.48 parts) was prepared as in Example 1-1 except that the amount of the hydroxygallium phthalocyanine pigment prepared in Synthesis Example 2 was 0.25 parts instead of 0.45 parts in Example 1-1 and that the amount of the chlorogallium phthalocyanine pigment prepared in Synthesis Example 3 was 0.25 parts instead of 0.05 parts in Example 1-1. FIG. 4 shows the powder X-ray diffraction pattern of the resulting crystalline complexes.

NMR measurement showed that the amount of N-methylformamide contained in the gallium phthalocyanine crystalline complexes prepared in Example 1-3 was 0.6% by mass relative to the amount of gallium phthalocyanine when calculated from the proton ratio.

### Example 1-4

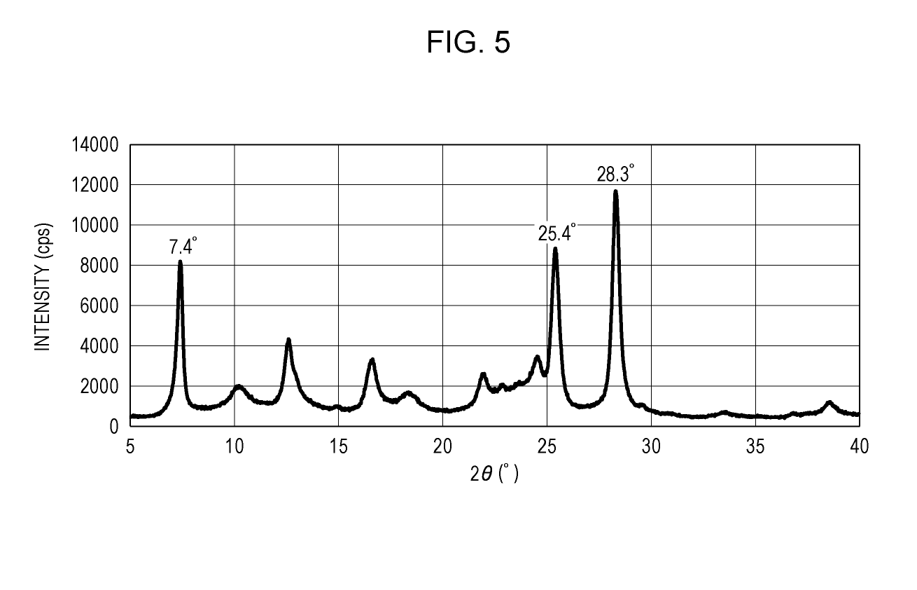

Gallium phthalocyanine crystalline complexes (0.47 parts) was prepared as in Example 1-1 except that the amount of the hydroxygallium phthalocyanine pigment prepared in Synthesis Example 2 was 0.10 parts instead of 0.45 parts in Example 1-1 and that the amount of the chlorogallium phthalocyanine pigment prepared in Synthesis Example 3 was 0.40 parts instead of 0.05 parts in Example 1-1. FIG. 5 shows the powder X-ray diffraction pattern of the resulting crystalline complexes.

NMR measurement showed that the amount of N-methylformamide contained in the gallium phthalocyanine crystalline complexes prepared in Example 1-4 was 0.6% by mass relative to the amount of gallium phthalocyanine when calculated from the proton ratio.

### Example 1-5

Gallium phthalocyanine crystalline complexes (0.48 parts) was prepared as in Example 1-1 except that the amount of the hydroxygallium phthalocyanine pigment prepared in Synthesis Example 2 was 0.05 parts instead of 0.45 parts in Example 1-1 and that the amount of the chlorogallium phthalocyanine pigment prepared in Synthesis Example 3 was 0.45 parts instead of 0.05 parts in Example 1-1. The powder X-ray diffraction pattern of the resulting gallium phthalocyanine crystalline complexes was similar to that shown in FIG. 5.

NMR measurement showed that the amount of N-methylformamide contained in the gallium phthalocyanine crystalline complexes prepared in Example 1-5 was 0.5% by mass relative to the amount of gallium phthalocyanine when calculated from the proton ratio.

### Example 1-6

Gallium phthalocyanine crystalline complexes (0.47 parts) was prepared as in Example 1-1 except that the compound (0.001 parts) represented by Formula (2-1) was further added in the milling treatment. The powder X-ray diffraction pattern of the resulting gallium phthalocyanine crystalline complexes was similar to that shown in FIG. 2.

NMR measurement showed that the amount of N-methylformamide contained in the gallium phthalocyanine crystalline complexes prepared in Example 1-6 was 0.6% by mass relative to the amount of gallium phthalocyanine when calculated from the proton ratio.

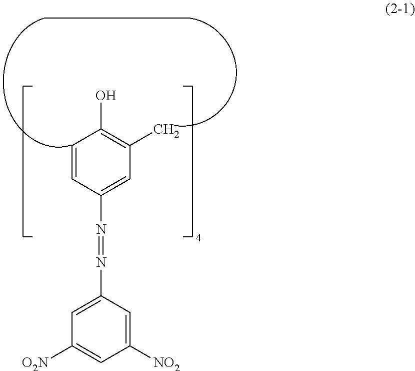

### Example 1-7

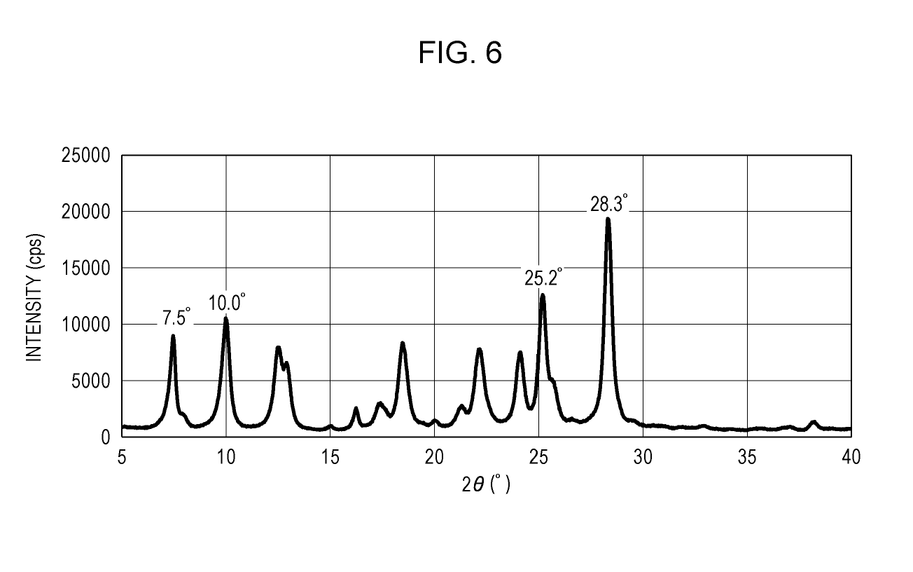

Gallium phthalocyanine crystalline complexes (0.48 parts) was prepared as in Example 1-2 except that the compound (0.001 parts) represented by Formula (2-1) was further added in the milling treatment. FIG. 6 shows the powder X-ray diffraction pattern of the resulting crystalline complexes.

NMR measurement showed that the amount of N-methylformamide contained in the gallium phthalocyanine crystalline complexes prepared in Example 1-7 was 0.6% by mass relative to the amount of gallium phthalocyanine when calculated from the proton ratio.

### Example 1-8

Gallium phthalocyanine crystalline complexes (0.47 parts) was prepared as in Example 1-3 except that the compound (0.001 parts) represented by Formula (2-1) was further added in the milling treatment. The powder X-ray diffraction pattern of the resulting gallium phthalocyanine crystalline complexes was similar to that shown in FIG. 4.

NMR measurement showed that the amount of N-methylformamide contained in the gallium phthalocyanine crystalline complexes prepared in Example 1-8 was 0.6% by mass relative to the amount of gallium phthalocyanine when calculated from the proton ratio.

### Example 1-9

Gallium phthalocyanine crystalline complexes (0.48 parts) was prepared as in Example 1-2 except that the compound (0.5 parts) represented by Formula (3-1) was further added in the milling treatment. The powder X-ray diffraction pattern of the resulting gallium phthalocyanine crystalline complexes was similar to that shown in FIG. 3. Note that Me in Formula (3-1) represents a methyl group.

NMR measurement showed that the amount of N-methylformamide contained in the gallium phthalocyanine crystalline complexes prepared in Example 1-9 was 0.6% by mass relative to the amount of gallium phthalocyanine when calculated from the proton ratio.

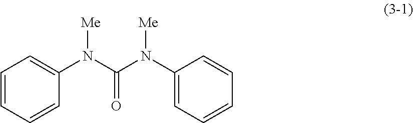 [SMILES: CN(C(=O)N(C)c1ccccc1)c1ccccc1]

### Example 1-10

Gallium phthalocyanine crystalline complexes (0.48 parts) was prepared as in Example 1-2 except that N-n-propylformamide (10 parts) was used instead of N-methylformamide (10 parts) in Example 1-2. The powder X-ray diffraction pattern of the resulting gallium phthalocyanine crystalline complexes was similar to that shown in FIG. 3.

NMR measurement showed that the amount of N-n-propylformamide contained in the gallium phthalocyanine crystalline complexes prepared in Example 1-10 was 0.6% by mass relative to the amount of gallium phthalocyanine when calculated from the proton ratio.

### Example 1-11

Gallium phthalocyanine crystalline complexes (0.47 parts) was prepared as in Example 1-2 except that N-vinylformamide (10 parts) was used instead of N-methylformamide (10 parts) in Example 1-2. The powder X-ray diffraction pattern of the resulting gallium phthalocyanine crystalline complexes was similar to that shown in FIG. 3.

NMR measurement showed that the amount of N-vinylformamide contained in the gallium phthalocyanine crystalline complexes prepared in Example 1-11 was 0.6% by mass relative to the amount of gallium phthalocyanine when calculated from the proton ratio.

### Comparative Example 1-1

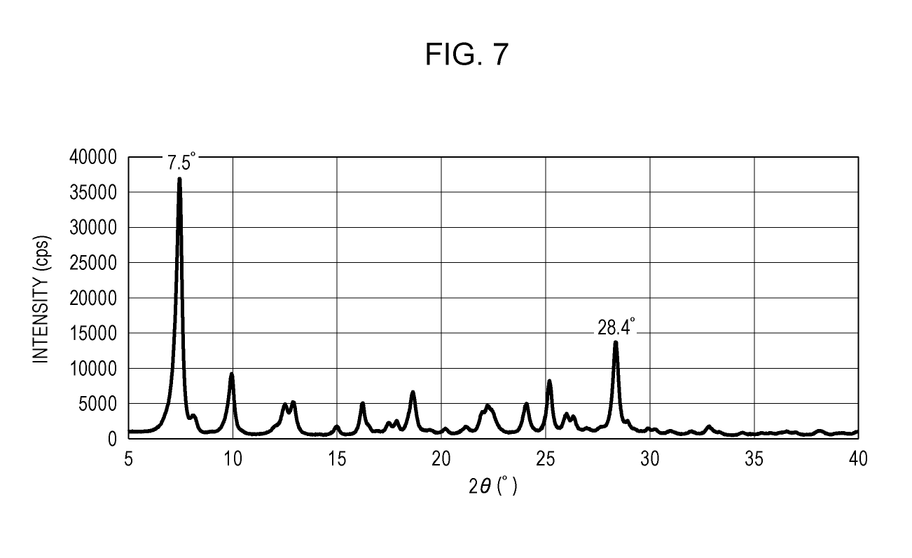

Hydroxygallium phthalocyanine crystals (0.45 parts) was prepared as in Example 1-1 except that the hydroxygallium phthalocyanine pigment (0.50 parts) prepared in Synthesis Example 2 was used instead of the hydroxygallium phthalocyanine pigment (0.45 parts) prepared in Synthesis Example 2 and the chlorogallium phthalocyanine pigment (0.05 parts) prepared in Synthesis Example 3, that N,N-dimethylformamide (10 parts) was used instead of N-methylformamide (10 parts), and that the milling time was 48 hr. FIG. 7 shows the powder X-ray diffraction pattern of the resulting crystals.

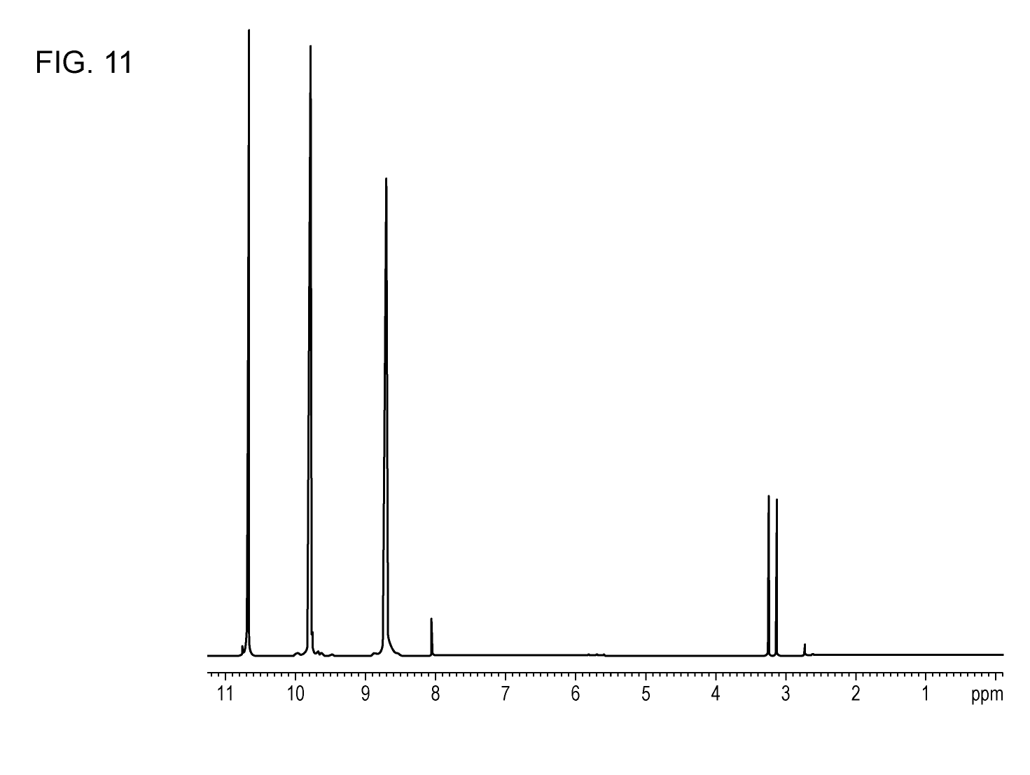

NMR measurement showed that the amount of N,N-dimethylformamide contained in the hydroxygallium phthalocyanine crystals prepared in Comparative Example 1-1 was 2.1% by mass relative to the amount of hydroxygallium phthalocyanine when calculated from the proton ratio. FIG. 11 shows an NMR spectrum of the resulting hydroxygallium phthalocyanine crystals.

### Comparative Example 1-2

Hydroxygallium phthalocyanine crystals (0.46 parts) was prepared as in Comparative Example 1-1 except that dimethylsulfoxide (10 parts) was used instead of N,N-dimethylformamide (10 parts) in Comparative Example 1-1.

NMR measurement showed that the amount of dimethylsulfoxide contained in the hydroxygallium phthalocyanine crystals prepared in Comparative Example 1-2 was 2.1% by mass relative to the amount of hydroxygallium phthalocyanine when calculated from the proton ratio.

### Comparative Example 1-3

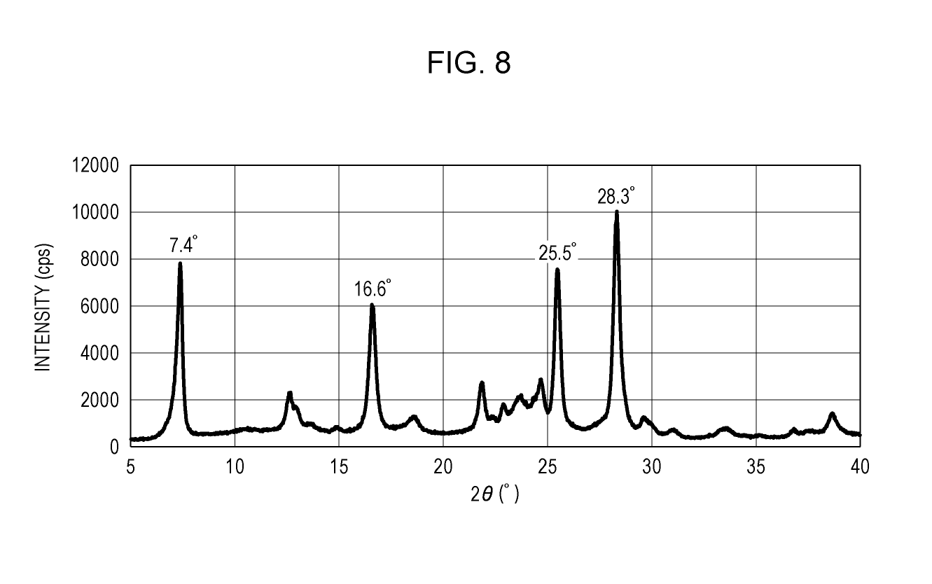

The chlorogallium phthalocyanine pigment (0.5 parts) prepared in Synthesis Example 1 was milled with a ball mill using glass beads (20 parts) having a diameter of 0.8 mm at room temperature (23° C.) for 48 hr. The milling was performed using a standardized bottle (product code: PS-6, manufactured by Hakuyo Glass Co., Ltd.) as the container under conditions such that the container rotates 120 times per minute. Subsequently, N,N-dimethylformamide (10 parts) was added to the container, and milling treatment was performed under the same conditions for 150 hr. Tetrahydrofuran (30 parts) was added to the thus-prepared dispersion. The mixture was filtered with a filter, and the filtrate remained on the filter was further sufficiently washed with tetrahydrofuran. The washed filtrate was vacuum-dried to give 0.48 parts of chlorogallium phthalocyanine crystals. FIG. 8 shows the powder X-ray diffraction pattern of the resulting crystals.

NMR measurement showed that the amount of N,N-dimethylformamide contained in the chlorogallium phthalocyanine crystals prepared in Comparative Example 1-3 was 0.9% by mass relative to the amount of chlorogallium phthalocyanine when calculated from the proton ratio.

### Examples 2-1 to 2-11 and Comparative Examples 2-1 to 2-3

### Example 2-1

Barium sulfate particles coated with tin oxide (trade name: Pastran PCl, manufactured by Mitsui Mining & Smelting Co., Ltd., 60 parts), titanium oxide particles (trade name: TITANIX JR, manufactured by manufactured by Tayca Corporation, 15 parts), a resol type phenolic resin (trade name: Phenolite J-325, manufactured by DIC Corporation, solid content: 70% by mass, 43 parts), silicone oil (trade name: SH28PA, manufactured by Dow Corning Toray Co., Ltd., 0.015 parts), a silicone resin (trade name: Tospearl 120, manufactured by Momentive Performance Materials Inc., 3.6 parts), 2-methoxy-1-propanol (50 parts), and methanol (50 parts) were placed in a ball mill and were dispersed for 20 hr to prepare a conductive layer coating solution.

This conductive layer coating solution was applied to a support, an aluminum cylinder (diameter: 24 mm), by dipping to form a coating film. The resulting coating film was dried at 140° C. for 30 min to form a conductive layer having a thickness of 15 μm.

Separately, a copolymer nylon resin (trade name: Amilan CM8000, manufactured by Toray Industries, Inc., 10 parts) and methoxymethylated 6-nylon resin (trade name: Trezin EF-30T, manufactured by Nagase ChemteX Corporation, 30 parts) were dissolved in a solvent mixture of methanol (400 parts) and n-butanol (200 parts) to prepare an undercoat layer coating solution.

This undercoat layer coating solution was applied onto the conductive layer by dipping to form a coating film. The resulting coating film was dried to form an undercoat layer having a thickness of 0.5 μm.

Separately, the gallium phthalocyanine crystalline complexes (charge generation material, 10 parts) prepared in Example 1-1, a polyvinyl butyral (trade name: Eslex BX-1, manufactured by Sekisui Chemical Co., Ltd., 5 parts), and cyclohexanone (250 parts) were mixed. The mixture was dispersed with a sand mill using glass beads having a diameter of 1 mm for 4 hr to prepare a dispersion. The dispersion was diluted with ethyl acetate (250 parts) to prepare a charge generation layer coating solution.

This charge generation layer coating solution was applied onto the undercoat layer by dipping to form a coating film. The resulting coating film was dried at 100° C. for 10 min to form a charge generation layer having a thickness of 0.16 μm.

Separately, the compound represented by Formula (5) (charge transport material, 8 parts) and a polycarbonate (trade name: Iupilon Z-200, manufactured by Mitsubishi Gas Chemical Company, Inc., 10 parts) were dissolved in monochlorobenzene (70 parts) to prepare a charge transport layer coating solution.

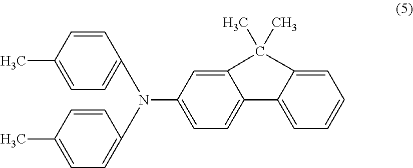 [SMILES: Cc1ccc(N(c2ccc(C)cc2)c2ccc3c(c2)C(C)(C)c2ccccc2-3)cc1]

The charge transport layer coating solution was applied onto the charge generation layer by dipping to form a coating film. The resulting coating film was dried at 110° C. for 1 hr to form a charge transport layer having a thickness of 23 μm.

Thus, a cylindrical (drum-shaped) electrophotographic photosensitive member of Example 2-1 was produced.

### Examples 2-2 to 2-11

Electrophotographic photosensitive members of Examples 2-2 to 2-11 were produced as in Example 2-1 except that the gallium phthalocyanine crystalline complexes prepared in Examples 1-2 to 1-11 were respectively used as the gallium phthalocyanine crystalline complexes in the preparation of the charge generation layer coating solutions.

### Comparative Examples 2-1 to 2-3

Electrophotographic photosensitive members of Comparative Examples 2-1 to 2-3 were prepared as in Example 2-1 except that the gallium phthalocyanine crystalline complexes prepared in Comparative Examples 1-1 to 1-3 were respectively used as the gallium phthalocyanine crystalline complexes in the preparation of the charge generation layer coating solutions.

### Comparative Example 2-4

An electrophotographic photosensitive members of Comparative Example 2-4 was prepared as in Example 2-1 except that the hydroxygallium phthalocyanine crystals (5 parts) prepared in Comparative Example 1-1 and chlorogallium phthalocyanine crystals (5 parts) prepared in Comparative Examples 1-3 were used instead of the gallium phthalocyanine crystalline complexes (10 parts) in the preparation of the charge generation layer coating solution.

### [Evaluation]

The electrophotographic photosensitive members produced above were subjected to ghost image evaluation as follows.

The electrophotographic apparatus used for the evaluation was a laser beam printer (trade name: Color Laser Jet CP3525dn, manufactured by Japan Hewlett-Packard Company) modified such that the printer was operated not turning on the pre-exposure light and being changeable the charging conditions and the image exposure light quantity. The electrophotographic photosensitive member produced above was mounted on the process cartridge for cyan and was attached to the station for the cyan process cartridge. The printer was also set such that the printer was operated even if the process cartridges for other colors (magenta, yellow, and black) were not mounted on the printer main body.

In output of an image, the cyan process cartridge only was attached to the main body, and a monochromatic image of the cyan toner only was output.

Under a normal temperature and normal humidity environment of 23° C. and 55% RH, the charging conditions and the image exposure light quantity were adjusted such that the initial dark area potential was −500 V and the initial light area potential was −100 V. In the measurement of the surface potential of the cylindrical electrophotographic photosensitive member in setting the potential, the cartridge was modified, a potential probe (trade name: model 6000B-8, manufactured by Trek Japan Co., Ltd.) was mounted on the developing position, and the potential at the central part of the cylindrical electrophotographic photosensitive member was measured with a surface electrometer (trade name: model 344, manufactured by Trek Japan Co., Ltd.).

Subsequently, ghost image evaluation was performed under the same conditions (the normal temperature and normal humidity environment). A repeating paper-feeding test was then performed for 1000 sheets. Immediately after and 15 hr after the repeating paper-feeding test, ghost image evaluation was performed. Table shows the results of evaluation under the normal temperature and normal humidity environment.

Subsequently, the electrophotographic photosensitive member was left to stand, together with the electrophotographic apparatus for evaluation, under a low temperature and low humidity environment of 15° C. and 10% RH for 3 days and was then subjected to ghost image evaluation. A repeating paper-feeding test was then performed for 1000 sheets under the same conditions (the low temperature and low humidity environment). Immediately after and 15 hr after the repeating paper-feeding test, ghost image evaluation was performed. Table shows the results of evaluation under the low temperature and low humidity environment.

In the repeating paper-feeding test, a cyan monochromatic E-letter image was printed on A4 plain paper at a printing ratio of 1%.

The ghost image evaluation was performed as follows.

In the ghost image evaluation, a solid white image was output on the first sheet, four types of ghost charts were then each output on a sheet, four sheets in total. Subsequently, a solid black image was output on a sheet, and the four types of ghost charts were then each output on a sheet, four sheets in total, again. Image output was performed in this order, and eight ghost images in total were evaluated. As the ghost charts, four solid black 25-mm squares were output in parallel with equal intervals in the area of 30 mm from the image output beginning position (10 mm from the upper end of the sheet) on a solid white background and four types of halftone printed patterns were output in the area of more than 30 mm from the image output beginning position. The ghost images were ranked based on these four types of ghost charts.

The four types of ghost charts differ from one another only in the halftone pattern in the area of more than 30 mm from the image output beginning position. The halftone patterns are the following four types:

(1) a printed (laser exposure) pattern with one dot and one space in the lateral direction*;

(2) a printed (laser exposure) pattern with two dots and two spaces in the lateral direction*;

(3) a printed (laser exposure) pattern with two dots and three spaces in the lateral direction*; and

(4) a printed (laser exposure) pattern of a “keima (similar to knight's jump)” pattern (a pattern with two dots printed in six squares like the move of a “keima” piece in Japanese chess (similar to the knight's jump direction)). *: The “lateral direction” refers to the scanning direction of a laser scanner (the horizontal direction of an output sheet).

The ghost images were classified into the following ranks by visual inspection. The ranks 4, 5, and 6 were determined to be insufficient in the effect of the present invention.

Rank 1: No ghost was visible in every ghost chart,

Rank 2: Ghost was slightly visible in a specific ghost chart,

Rank 3: Ghost was slightly visible in every ghost chart,

Rank 4: Ghost was visible in a specific ghost chart,

Rank 5: Ghost was visible in every ghost chart, and

Rank 6: Ghost was clearly visible in a specific ghost chart.

| | TABLE | | | | | |
|---|---|---|---|---|---|---|
| | Rank of ghost | | | | | |
| | Under normal temperature and | | | Under low temperature and | | |
| | normal humidity environment | | | low humidity environment | | |
| | | Immediately | 15 hr | | Immediately | 15 hr |
| | | after repeating | after repeating | | after repeating | after repeating |
| | | paper-feeding | paper-feeding | | paper-feeding | paper-feeding |
| | Initial | test | test | Initial | test | test |
| Example 2-1 | 1 | 2 | 2 | 1 | 2 | 2 |
| Example 2-2 | 1 | 2 | 2 | 1 | 2 | 2 |
| Example 2-3 | 1 | 2 | 2 | 2 | 2 | 2 |
| Example 2-4 | 2 | 2 | 2 | 2 | 3 | 3 |
| Example 2-5 | 1 | 2 | 2 | 2 | 3 | 3 |
| Example 2-6 | 1 | 1 | 1 | 1 | 1 | 1 |
| Example 2-7 | 1 | 1 | 1 | 1 | 1 | 1 |
| Example 2-8 | 1 | 1 | 1 | 1 | 2 | 2 |
| Example 2-9 | 1 | 1 | 1 | 1 | 2 | 1 |
| Example 2-10 | 1 | 2 | 2 | 2 | 3 | 2 |
| Example 2-11 | 1 | 2 | 2 | 2 | 3 | 2 |
| Comparative | 4 | 5 | 4 | 5 | 6 | 5 |
| Example 2-1 | | | | | | |
| Comparative | 4 | 5 | 5 | 5 | 6 | 6 |
| Example 2-2 | | | | | | |
| Comparative | 2 | 3 | 3 | 3 | 4 | 4 |
| Example 2-3 | | | | | | |
| Comparative | 3 | 4 | 4 | 4 | 5 | 5 |
| Example 2-4 | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-039419, filed Feb. 27, 2015, which is hereby incorporated by reference herein in its entirety.

What is claimed is:

1. An electrophotographic photosensitive member comprising:
a support, and
a photosensitive layer, wherein
the photosensitive layer contains a crystalline complex comprising hydroxygallium phthalocyanine and chlorogallium phthalocyanine, the crystalline complex containing an amide compound represented by Formula (1):
R¹—NHCHO (1)
where R¹ represents a methyl group, a propyl group, or a vinyl group.

2. The electrophotographic photosensitive member according to claim 1, wherein the amide compound represented by Formula (1) is N-methylformamide.

3. The electrophotographic photosensitive member according to claim 1, wherein
the photosensitive layer includes a charge generation sub-layer and a charge transport sub-layer in this order from the support side; and
the crystalline complex is contained in the charge generation sub-layer.

4. The electrophotographic photosensitive member according to claim 1, wherein
the crystalline complex has peaks at Bragg angles 2θ of 7.40±0.30 and 28.30±0.30 in an X-ray diffraction spectrum with CU—Kα ray.

5. The electrophotographic photosensitive member according to claim 1, wherein
the crystalline complex has a ratio of the content of hydroxygallium phthalocyanine to the content of chlorogallium phthalocyanine of 5/5 or more.

6. The electrophotographic photosensitive member according to claim 1, wherein
the crystalline complex has a ratio of the content of hydroxygallium phthalocyanine to the content of chlorogallium phthalocyanine of 70/30 or more and 95/5 or less.

7. The electrophotographic photosensitive member according to claim 1, wherein
the crystalline complex contains the amide compound represented by Formula (1) in an amount of 0.1% by mass or more and 3.0% by mass or less.

8. The electrophotographic photosensitive member according to claim 1, wherein
the crystalline complex further contains a compound represented by Formula (2): 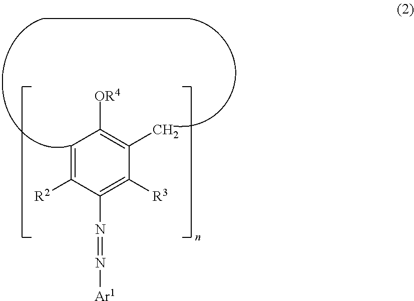
where n represents an integer of 4 to 8; R²'s each independently represent a hydrogen atom or an alkyl group; R³'s each independently represent a hydrogen atom or an alkyl group; R⁴'s each independently represent a hydrogen atom or a substituted or unsubstituted alkyl group; and Ar¹'s each independently represent a substituted or unsubstituted aromatic hydrocarbon ring, a substituted or unsubstituted heterocycle, or a monovalent group formed by bonding of two or more groups selected from the group consisting of substituted aromatic hydrocarbon rings, unsubstituted aromatic hydrocarbon rings, substituted heterocycles, and unsubstituted heterocycles.

9. The electrophotographic photosensitive member according to claim 1, wherein
the crystalline complex further contains a compound represented by Formula (3) or (4): 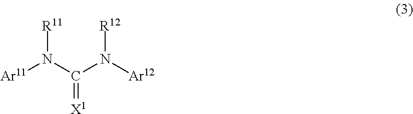
where R¹¹ and R¹² each independently represent a hydrogen atom or an alkyl group; X¹ represents an oxygen atom or a sulfur atom; and Ar¹¹ and Ar¹² each independently represent a hydrogen atom or a substituted or unsubstituted aryl group, provided that at least one of Ar¹¹ and Ar¹² represents a substituted or unsubstituted aryl group, wherein
the substituent of the substituted aryl group is a cyano group, a dialkylamino group, a hydroxy group, an alkyl group, an alkoxy-substituted alkyl group, a halogen-substituted alkyl group, an alkoxy group, an alkoxy-substituted alkoxy group, a halogen-substituted alkoxy group, a nitro group, or a halogen atom, 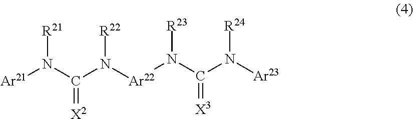
where R²¹ to R²⁴ each independently represent a hydrogen atom or an alkyl group; X² and X³ each independently represent an oxygen atom or a sulfur atom; Ar²² represents a substituted or unsubstituted arylene group; and Ar²¹ and Ar²³ each independently represent a hydrogen atom or a substituted or unsubstituted aryl group, provided that at least one of Ar²¹ and Ar²³ represents a substituted or unsubstituted aryl group, wherein
the substituent of the substituted arylene group is an alkyl group, an alkoxy-substituted alkyl group, a halogen-substituted alkyl group, an alkoxy group, an alkoxy-substituted alkoxy group, a halogen-substituted alkoxy group, or a halogen atom; and
the substituent of the substituted aryl group is a cyano group, a dialkylamino group, a hydroxy group, an alkyl group, an alkoxy-substituted alkyl group, a halogen-substituted alkyl group, an alkoxy group, an alkoxy-substituted alkoxy group, a halogen-substituted alkoxy group, a nitro group, or a halogen atom.

10. A process cartridge detachably attachable to an electrophotographic apparatus main body, the process cartridge comprising:
an electrophotographic photosensitive member including a support and a photosensitive layer; and
at least one device selected from the group consisting of a charging device, a developing device, and a cleaning device, wherein
the electrophotographic photosensitive member and at least one device selected from the group consisting of the charging device, the developing device, and the cleaning device are integrally supported in the process cartridge; and
the photosensitive layer of the electrophotographic photosensitive member contains a crystalline complex comprising hydroxygallium phthalocyanine and chlorogallium phthalocyanine, the crystalline complex containing an amide compound represented by Formula (1):
R¹—NHCHO (1)
where R¹ represents a methyl group, a propyl group, or a vinyl group.

11. An electrophotographic apparatus comprising:
an electrophotographic photosensitive member,
a charging device,
an exposure device,
a developing device, and
a transferring device, wherein
the electrophotographic photosensitive member includes a support and a photosensitive layer, wherein
the photosensitive layer contains a crystalline complex comprising hydroxygallium phthalocyanine and chlorogallium phthalocyanine, the crystalline complex containing an amide compound represented by Formula (1):
R¹—NHCHO (1)
where R¹ represents a methyl group, a propyl group, or a vinyl group.

12. A crystalline complex comprising hydroxygallium phthalocyanine and chlorogallium phthalocyanine, the crystalline complex containing an amide compound represented by Formula (1):
R¹—NHCHO (1)
where R¹ represents a methyl group, a propyl group, or a vinyl group.

13. A method of producing crystalline complexes of hydroxygallium phthalocyanine and chlorogallium phthalocyanine, the method comprising:
wet-milling hydroxygallium phthalocyanine prepared by acid pasting, chlorogallium phthalocyanine, and an amide compound represented by Formula (1):
R¹—NHCHO (1)
where R¹ represents a methyl group, a propyl group, or a vinyl group, wherein
the crystalline complexes contain the amide compound represented by Formula (1) therein.
